(19) United States
(12) Patent Application Publication
(10) Pub. No.: US 2026/0275122 A1
(43) Pub. Date: Sep. 17, 2026

(54) ANTI-ICING COATING, AND PREPARATION METHOD THEREFOR AND USE THEREOF

(71) Applicant: TSINGHUA UNIVERSITY, Beijing (CN)

(72) Inventors: Jinjin LI, Beijing (CN); Rui ZHANG, Beijing (CN)

(21) Appl. No.: 19/164,055

(22) PCT Filed: May 12, 2023
(86) PCT No.: PCT/CN2023/093943

§ 371 Date: Sep. 10, 2025

(30) Foreign Application Priority Data
Mar. 14, 2023 (CN) 202310261316.5

(51) Int. Cl. C09D 5/16; C09D 7/40; C09D 7/61; C09D 7/65; C09D 7/80; C09D 127/18; C09D 171/02; C09D 183/04

(52) U.S. Cl. CPC C09D 5/1675; C09D 5/1668; C09D 7/61; C09D 7/65; C09D 7/67; C09D 7/68; C09D 7/69; C09D 7/70; C09D 7/80; C09D 127/18; C09D 171/02; C09D 183/04

(57) ABSTRACT

A method for preparing an anti-icing coating includes: adding a mixture of an expandable microsphere and a photothermal nanomaterial to a high-temperature curable resin diluted with a diluent solvent, and uniformly dispersing a solution formed thereby to obtain a colloidal solution; transferring the colloidal solution to a surface of a substrate, heating the substrate with the colloidal solution attached thereto to volatilize the diluent solvent, and continuing heating the substrate to expand the expandable microsphere in the colloidal solution and to cure the high-temperature curable resin at or above an initial expansion temperature of the expandable microsphere; and heating the substrate to a maximum expansion temperature of the expandable microsphere to shrink the expanded microsphere, and cooling to obtain a three-dimensional porous coating; and performing a surface treatment on the three-dimensional porous coating, and injecting an oily liquid to obtain the anti-icing coating.

### CROSS-REFERENCE TO RELATED APPLICATIONS

This application is a national stage entry under 35 U.S.C. § 371 of International Patent Application No. PCT/CN2023/093943, filed May 12, 2023, which claims priority to Chinese Patent Application No. 202310261316.5, filed on Mar. 14, 2023, the entire disclosures of which are hereby incorporated herein by reference.

### TECHNICAL FIELD

The present disclosure generally relates to the technical field of functional material preparation, and more particularly relates to an anti-icing coating and a preparation method and use thereof.

### BACKGROUND

Icing phenomenon is widely present in nature, especially in low temperature and high humidity environments. In various fields such as aviation, power transportation, communications, and ground transportation, icing has a very adverse impact on industrial facilities including transportation systems, telecommunications systems, and energy systems, often causing catastrophic safety problems and huge economic losses.

In the related art, many active anti-icing and de-icing strategies (including electric or steam heating melting, de-icing chemicals, and mechanical force) are applied to ice and snow on cold surfaces (such as aircraft wings, ship decks, wind turbine blades, car windows and windshields, and winter roads) in sub-zero environments. The more common ones include spraying antifreeze on the fuselage to prevent water from icing, spreading salt on roads to reduce traffic accidents caused by ice and snow in winter, and mechanical de-icing of power transmission lines to prevent line collapse and safety issues. However, such active de-icing methods, including electrothermal, chemical and mechanical methods, often face one or more problems including high cost, low efficiency, high energy consumption, complex design and environmental pollution.

In the related art, constructing passive anti-icing/de-icing materials and surfaces that may repel water droplets, inhibit icing, reduce an icing adhesion strength, and have zero energy consumption is also one of the most economical and effective methods to prevent icing. Two typical types are non-wetting (super-hydrophobic) surfaces and liquid-injected smooth surfaces. The super-hydrophobic surfaces may capture air and form air pockets at a solid-liquid interface, which may minimize to a greatest extent an effective contact area between supercooled droplets and cold solid substrates to inhibit icing. However, a defect of this interface is that it may form a high-energy solid-liquid interface. At low temperatures, this interface may promote heterogeneous nucleation of ice, destroy pockets in a structure, and thus lead to higher icing adhesion strength. It also has defects of easy damage to a microstructure and insufficient stability. The liquid-injected smooth surfaces convert the pockets in the super-hydrophobic surface into an addable oil film or other liquids that are not easy to ice at low temperatures and are not miscible with water, effectively preventing water from icing in contact with the material surface. However, since the injected liquid is extremely easy to migrate, evaporate or leak, a durability of the liquid-injected smooth surface remains a challenge.

### SUMMARY

The present disclosure aims to solve one of the technical problems existing in the related art to at least a certain extent. To this end, embodiments of a first aspect of the present disclosure provide a method for preparing an anti-icing coating.

Embodiments of a second aspect of the present disclosure provide an anti-icing coating prepared by the above method.

Embodiments of a third aspect of the present disclosure provide use of the above anti-icing coating.

To this end, embodiments of a first aspect of the present disclosure provide a method for preparing an anti-icing coating, which includes:
in S1, adding a mixture of an expandable microsphere and a photothermal nanomaterial to a high-temperature curable resin diluted with a diluent solvent, and uniformly dispersing a solution formed thereby to obtain a colloidal solution;
in S2, transferring the colloidal solution to a surface of a substrate, heating the substrate with the colloidal solution attached thereto to volatilize the diluent solvent, and continuing heating the substrate to expand the expandable microsphere in the colloidal solution and to cure the high-temperature curable resin at or above an initial expansion temperature of the expandable microsphere; and heating the substrate to a maximum expansion temperature of the expandable microsphere to shrink the expanded microsphere, and cooling to obtain a three-dimensional porous coating; and
in S3, performing a surface treatment on the three-dimensional porous coating, and injecting an oily liquid to obtain the anti-icing coating.

In some embodiments, the expandable microsphere has a particle size of 10 to 50 μm, the initial expansion temperature of 80 to 100° C., and the maximum expansion temperature of 120 to 140° C.

In some embodiments, the photothermal nanomaterial has a particle size of 20 nm to 5 μm.

In some embodiments, the photothermal nanomaterial is one or more of graphene, black phosphorus, MXene, ferroferric oxide, or lignin; and the MXene is a two-dimensional material with a structural formula Mₙ₊₁Xₙ, where n=1, 2, 3, X is C or N, and M is one of Sc, Ti, V, Cr, Zr, Nb, Mo, Hf or Ta.

In some embodiments of the present disclosure, the photothermal nanomaterial is a two-dimensional Mo₂C material (with a photothermal conversion efficiency close to 100%).

In some embodiments, an amount of the expandable microsphere is 8 to 12% of a mass of the high-temperature curable resin, and an amount of the photothermal nanomaterial is 10 to 20% of the mass of the high-temperature curable resin.

In some embodiments, the high-temperature curable resin is one or more of polydimethylsiloxane, amorphous fluoropolymer, polytetrafluoroethylene, or polychlorotrifluoroethylene; and in some embodiments, the high-temperature curable resin is polydimethylsiloxane.

In some embodiments, the oily liquid is dimethyl silicone oil or perfluoropolyether oil.

In some embodiments, the oily liquid in the S3 is of the same property and highly compatible with the high-temperature curable resin in the S1; for example, in a case where the high-temperature curable resin is polydimethylsiloxane, the oily liquid is dimethyl silicone oil. In a case where the high-temperature curable resin is one or more of polytetrafluoroethylene, polychlorotrifluoroethylene, or amorphous fluoropolymer, the oily liquid is perfluoropolyether oil.

In some embodiments, in the S2, the colloidal solution is used in such an amount that makes the high-temperature curable resin corresponding thereto satisfies 100 to 300 μL/cm².

In some embodiments, in the S3, an injection amount of the oily liquid is 200 μL/cm² to a maximum adsorption capacity.

In some embodiments, in the S1, the dispersion is carried out by an ultrasonic treatment with a frequency of 20 to 30 kHz for 6 to 8 h.

In some embodiments, in the S1, the colloidal solution is maintained for 30 min to 2 h at or above the initial expansion temperature of the expandable microsphere to expand the expandable microsphere in the colloidal solution and to cure the high-temperature curable resin; and then is heated to the maximum expansion temperature of the expandable microsphere and maintained for 4 to 6 h to shrink the expanded microsphere.

In some embodiments, in the S2, before transferring the colloidal solution to the surface of the substrate, the surface of the substrate is subjected to a pretreatment, and the pretreatment includes sandblasting or acid etching to make the surface of the substrate have a roughness of 3 to 15 μm.

In some embodiments, in the S2, the pretreatment further includes coating the surface of the substrate with an oil gel after sandblasting or acid etching, followed by curing and forming; and the oil gel is a mixture of an oily liquid and a high-temperature curable resin in a volume ratio of 1:2, and the oil gel is coated in an amount of 100 L/cm². The oil gel itself may gradually release the oily liquid contained inside from an inner network to an outer layer, which is beneficial to increase the oil storage performance of the three-dimensional porous coating and ensure more lasting and stable low icing adhesion features.

In some embodiments, the oily liquid in a preparation of the oil gel is selected the same as the oily liquid in the S3 (which may further improve an affinity between the three-dimensional porous coating and the oily liquid added in the S3); and the high-temperature curable resin in the preparation of the oil gel is selected the same as the high-temperature curable resin in the S1.

In some embodiments, in the S3, the surface treatment is polishing the three-dimensional porous coating.

In some embodiments, the substrate is selected from a metallic material, a non-metallic material, an inorganic material, an organic material or a composite material. For example, the substrate may be an Al sheet, high chromium bearing steel, stainless steel, glass or a silicon sheet.

In a second aspect, embodiments of the present disclosure further provide an anti-icing coating, which is prepared by the method of any embodiment of the above first aspect.

In a third aspect, embodiments of the present disclosure further provide use of the anti-icing coating of any embodiment of the above second aspect, and the anti-icing coating is used in fields of electricity, transportation, communication or aviation.

In some embodiments, the anti-icing coating is used for anti-frost of a heat exchanger, anti-icing of a wind turbine blade, anti-icing of a vehicle, anti-icing of a ship, anti-icing of an aircraft surface, or anti-icing of a power and communication facility.

### BRIEF DESCRIPTION OF THE DRAWINGS

The above and/or additional aspects and advantages of the present disclosure will become apparent and readily appreciated from the following descriptions of embodiments made with reference to the drawings, in which:

FIG. 1 is a cross-sectional characterization diagram of a three-dimensional porous coating prepared in Example 1;

FIG. 2 is a schematic diagram of an icing adhesion strength testing device adopted in embodiments of the present disclosure;

FIG. 3 is a change diagram in anti-icing adhesion strengths of substrates with and without an anti-icing coating in Example 1;

FIG. 4 is a change diagram in anti-icing adhesion strengths of substrates with and without an anti-icing coating in Example 2;

FIG. 5 is a change diagram in anti-icing adhesion strengths of substrates with and without an anti-icing coating in Example 3;

FIG. 6 is an icing adhesion strength diagram of a substrate with an anti-icing coating prepared in Example 5;

FIG. 7 is an icing adhesion strength diagram of a substrate with an anti-icing coating prepared in Example 6;

FIG. 8 is a comparison diagram of icing adhesion strength of substrates with anti-icing coatings prepared in Comparative Examples 1, 2, 3, 4, and 5;

FIG. 9 is a comparison diagram of photothermal effects of substrates with and without an anti-icing coating in Example 1;

FIG. 10 is a comparison diagram of delayed icing time of substrates with and without an anti-icing coating in Example 1;

FIG. 11 is a cross-sectional characterization diagram of a three-dimensional porous coating prepared in Example 4;

FIG. 12 is a result diagram of testing an affinity of a three-dimensional porous coating prepared in Example 4 for dimethyl silicone oil selected;

FIG. 13 is a robustness diagram of a low icing adhesion performance of a coating in Example 4; and

FIG. 14 is a cross-sectional characterization comparison diagram of coatings prepared by adding expandable microspheres in different proportions.

### DETAILED DESCRIPTION

The embodiments of the present disclosure are described in detail below. The embodiments described below are illustrative and intended to be used to explain the present disclosure, but should not be construed as limiting the present disclosure.

Unless defined otherwise, all technical and scientific terms used herein have the same meaning as commonly understood by those skilled in the art to which the present disclosure belongs.

In this context, the term “and/or” is merely a description of an associated relationship of associated objects, means that there may be three relationships, for example, A and/or B, which may mean that A exists alone, A and B exist at the same time, and B exists alone.

In this context, the term “a plurality of” means more than two (including two).

In this context, in a case where values are described as ranges, it should be understood that such disclosure includes disclosures of all possible sub-ranges within that range, as well as specific values falling within that range, regardless of whether a specific value or a specific sub-range is explicitly stated.

In this context, the term “about” means +/−10% of a recited value.

Unless stated otherwise, raw materials and reagents used in the following examples are commercially available or may be prepared by known methods.

Embodiments of the present disclosure provide a method for preparing an anti-icing coating, which includes:
in S1, adding a mixture of an expandable microsphere and a photothermal nanomaterial to a high-temperature curable resin diluted with a diluent solvent, and uniformly dispersing a solution formed thereby to obtain a colloidal solution;
in S2, transferring the colloidal solution to a surface of a substrate, heating the substrate with the colloidal solution attached thereto to volatilize the diluent solvent, and continuing heating the substrate to expand the expandable microsphere in the colloidal solution and to cure the high-temperature curable resin at or above an initial expansion temperature of the expandable microsphere; and heating the substrate to a maximum expansion temperature of the expandable microsphere to shrink the expanded microsphere, and cooling to obtain a three-dimensional porous coating; and
in S3, performing a surface treatment on the three-dimensional porous coating, and injecting an oily liquid to obtain the anti-icing coating.

The embodiments of the present disclosure provide a method for preparing a three-dimensional porous oleophilic anti-icing coating based on the expandable microsphere and the photothermal nanomaterial. The method provided by the embodiments of the present disclosure mainly adopts an active and passive combination manner, that is, a combination of a photothermal conversion of the photothermal nanomaterial and a low icing adhesion feature of the coating itself, which may be prepared on a surface of general commonly used substrates (such as AL, GCr15, stainless steel, silicon sheets, etc.). A photothermal effect and an oil film generated during a preparation process of the coating itself may greatly reduce an icing adhesion strength of the surface and delay an icing time, while greatly improving a robustness of low icing adhesion performance of the coating, further reducing damage and losses caused by icing on a surface of the substrate.

In some embodiments, the expandable microsphere has a particle size of 10 to 50 μm, the initial expansion temperature of 80 to 100° C., and the maximum expansion temperature of 120 to 140° C.

In some embodiments, the expandable microsphere is of a core-shell structure, the core is a hydrocarbon, and the shell is an acrylonitrile copolymer. It is understood that the expandable microsphere begins to expand and/or foam (where the shell softens, alkane inside the shell vaporizes and expands, and a volume of the microsphere increases by dozens or hundreds of times, thereby achieving foaming effect.) when heated to a temperature above about the initial expansion temperature, and begins to shrink at a maximum expansion (shrinkage) temperature.

In some embodiments, the expandable microsphere in the embodiments of the present disclosure is selected from 642 WU 40 (an average particle size of 10 to 16 μm, an expansion initial temperature of 87 to 93° C., and a maximum expansion (shrinkage) temperature of 127 to 135° C.) produced by Expancel, the Netherlands. Alternatively, it may be model U41 (an average particle size of 10 to 20 μm, an expansion initial temperature of 80 to 85° C., and a maximum expansion (shrinkage) temperature of 120 to 130° C.) of Foshan Jusheng Chemical Co., Ltd.

In some embodiments, the photothermal nanomaterial has a particle size of 20 nm to 5 μm.

In some embodiments, the photothermal nanomaterial is one or more of graphene, black phosphorus, MXene, ferroferric oxide, or lignin; and the MXene is a two-dimensional material with a structural formula Mn₊₁Xₙ, where n=1, 2, 3, X is C or N, and M is one of Sc, Ti, V, Cr, Zr, Nb, Mo, Hf or Ta.

In some embodiments of the present disclosure, the photothermal nanomaterial is a two-dimensional Mo₂C material (with a photothermal conversion efficiency close to 100%).

In some embodiments, an amount of the expandable microsphere is 8 to 12% (10% in some embodiments) of a mass of the high-temperature curable resin, and an amount of the photothermal nanomaterial is 10 to 20% of the mass of the high-temperature curable resin. For non-limiting examples, a proportion of the expandable microsphere may be 8 wt. %, 9 wt. %, 10 wt. %, 11 wt. %, 12 wt. %, etc., and a proportion of the photothermal nanomaterial may be 10 wt. %, 12 wt. %, 14 wt. %, 16 wt. %, 18 wt. %, 20 wt. %, etc. The inventors have discovered that an addition content of the expandable microsphere has a very important influence on a construction of the three-dimensional coating. In a case where the addition content is low, a three-dimensional porous connected domain cannot be formed, resulting in the oily liquid further added in the S3 not being absorbed into an interior, thereby affecting a robustness of the low icing adhesion feature of the prepared coating; in a case where the expandable microsphere is added to an appropriate proportion, a three-dimensional porous connected domain may be formed on its surface, and a size of its porosity is closely related to an addition proportion. After experimental exploration, it has been found that in a case where the proportion of the expandable microsphere is 8%, a porous structure just begin to form inside it. When 10% or 12% of the expandable microsphere is added, the porosity inside it further increases. In a case where the addition proportion is increased to 15%, a squeezing effect between the microspheres during an expansion process is aggravated due to a high addition proportion of the expandable microsphere, which further limits an expansion performance of a part of microspheres and the porosity is further reduced. Therefore, in the present disclosure, the addition proportion of the expandable microspheres is controlled to be 8 to 12 wt. %.

In some embodiments, the high-temperature curable resin is one or more of polydimethylsiloxane, amorphous fluoropolymer, polytetrafluoroethylene, or polychlorotrifluoroethylene; and in some embodiments, the high-temperature curable resin is polydimethylsiloxane.

In some embodiments, in a case where the high-temperature curable resin is one or more of polydimethylsiloxane, polytetrafluoroethylene, or polychlorotrifluoroethylene, the diluent solvent in the S1 may be selected from tetrahydrofuran, toluene, dichloromethane, ethyl acetate, etc.

In some embodiments, in a case where the high-temperature curable resin is the amorphous fluoropolymer, the diluent solvent in the S1 may be selected from perfluoro(2-butenyltetrahydrofuran), perfluoro(tributylamine), perfluorohexane, perfluorooctylethylene, perfluorooctane, FC-40 fluorinated liquid (3M™ Fluorinert™ electronic fluorinated liquid), etc. It is understandable that the high-temperature curable resin diluted with the diluent solvent in the S1 may be directly selected from commercial products, such as Teflon™ AF series, for example, Teflon™ AF1601, Teflon™ AF2400, etc.

In some embodiments, the oily liquid is dimethyl silicone oil or perfluoropolyether oil.

In some embodiments, the oily liquid in the S3 is of the same property and highly compatible with the high-temperature curable resin in the S1; for example, in a case where the high-temperature curable resin is polydimethylsiloxane, the oily liquid is dimethyl silicone oil. In a case where the high-temperature curable resin is one or more of polytetrafluoroethylene, polychlorotrifluoroethylene, or amorphous fluoropolymer, the oily liquid is perfluoropolyether oil.

In some embodiments, in the S2, the colloidal solution is used in such an amount that makes the high-temperature curable resin corresponding thereto satisfies 100 to 300 AL/cm². Non-limiting examples include: 100 μL/cm², 150 μL/cm², 180 μL/cm², 200 μL/cm², 250 μL/cm², 300 μL/cm², etc.

In some embodiments, in the S3, an injection amount of the oily liquid is 200 μL/cm² to a maximum adsorption capacity. For non-limiting examples, the injection amount of the oily liquid may be 200 μL/cm², 210 μL/cm², 220 μL/cm², 240 μL/cm², 250 μL/cm², etc.; it may be understood that in actual operation, the oily liquid may also be added in excess to achieve its maximum adsorption capacity. For example, after adding an excessive amount of the oily liquid to a surface-treated three-dimensional porous coating and leaving it for 30 min, a sample is placed vertically at 90° for 10 h to allow excess oily liquid on an outer layer of a surface of the three-dimensional porous coating to drain.

In some embodiments, in the S1, the dispersion is carried out by an ultrasonic treatment with a frequency of 20 to 30 kHz for 6 to 8 h. For non-limiting examples, the frequency of the ultrasonic treatment may be 20 kHz, 25 kHz, 30 kHz, etc., and the time may be 6 h, 6.5 h, 7 h, 7.5 h, 8 h, etc.

In some embodiments, in the S1, the colloidal solution is maintained for 30 min to 2 h (non-limiting examples including that the time may be 30 min, 1 h, 1.2 h, 1.5 h, 2 h, etc.) at or above the initial expansion temperature of the expandable microsphere to expand the expandable microsphere in the colloidal solution and to cure the high-temperature curable resin; and then is heated to the maximum expansion temperature of the expandable microsphere and maintained for 4 to 6 h (non-limiting examples including that the time may be 4 h, 4.5 h, 5 h, 5.5 h, 6 h, etc.) to shrink the expanded microsphere.

In some embodiments, in the S2, before transferring the colloidal solution to the surface of the substrate, the surface of the substrate is subjected to a pretreatment, and the pretreatment includes sandblasting or acid etching to make the surface of the substrate have a roughness of 3 to 15 μm. Non-limiting examples include achieving a uniform surface roughness level of about 3 μm, 6 μm, 8 μm, 9 μm, 10 μm, 12 μm, 15 μm, etc.

In some embodiments, in the S2, the pretreatment further includes coating the surface of the substrate with an oil gel after sandblasting or acid etching, followed by curing and forming; and the oil gel is a mixture of an oily liquid and a high-temperature curable resin in a volume ratio of 1:2, and the oil gel is coated in an amount of 100 μL/cm². The oil gel itself may gradually release the oily liquid contained inside from an inner network to an outer layer, which is beneficial to increase the oil storage performance of the three-dimensional porous coating and ensure more lasting and stable low icing adhesion features.

In some embodiments, the oily liquid in a preparation of the oil gel is selected the same as the oily liquid in the S3 (which may further improve an affinity between the three-dimensional porous coating and the oily liquid added in the S3); and the high-temperature curable resin in the preparation of the oil gel is selected the same as the high-temperature curable resin in the S1.

In some embodiments, in the S3, the surface treatment is polishing the three-dimensional porous coating to remove a surface cured resin to expose internal pores.

In some embodiments, the substrate is selected from a metallic material, a non-metallic material, an inorganic material, an organic material or a composite material. For example, the substrate may be an Al sheet, high chromium bearing steel, stainless steel, glass or a silicon sheet.

In a second aspect, embodiments of the present disclosure further provide an anti-icing coating, which is prepared by the method of any embodiment of the above first aspect.

In a third aspect, embodiments of the present disclosure further provide use of the anti-icing coating of any embodiment of the above second aspect, and the anti-icing coating is used in fields of electricity, transportation, communication or aviation.

In some embodiments, the anti-icing coating is used for anti-frost of a heat exchanger, anti-icing of a wind turbine blade, anti-icing of a vehicle, anti-icing of a ship, anti-icing of an aircraft surface, or anti-icing of a power and communication facility.

The embodiments of the present disclosure have the following advantages and beneficial effects.

The embodiments of the present disclosure provide the method for preparing the three-dimensional porous oleophilic anti-icing coating based on the synergistic coupling of the expandable microsphere (expansion and shrinkage effect of the expandable microsphere) and the photothermal nanomaterial (photothermal effect). The method provided by the embodiments of the present disclosure mainly adopts the active and passive combination manner, that is, the combination of the photothermal conversion of the photothermal nanomaterial and the low icing adhesion features of the coating itself, which may be prepared on the surface of general commonly used substrates (such as AL, GCr15, stainless steel, silicon sheets, etc.). The photothermal effect and the oil film generated during the preparation process of the coating itself may greatly reduce the icing adhesion strength of the surface and delay the icing time. At the same time, due to a high affinity of the three-dimensional porous structure and the resin itself to the selected oil, long-term storage of the oil may be achieved, greatly improving the robustness of the low icing adhesion performance of the coating, further reducing the damage and losses caused by icing on the surface of the substrate.

The following are non-limiting examples and comparative examples of the present disclosure.

Single-layer molybdenum carbide powders with a flake diameter of 1 to 3 μm, a thickness of 5 nm and a purity of 98% were purchased from Suzhou Beike Nano Co., Ltd.

Lignin powders with a particle size of 50 nm to 1 μm and a purity of 93% were purchased from Shanghai Aladdin Biochemical Technology Co., Ltd.

A high-quality thin-layer graphene (model XF182-1) with a sheet diameter of 2 to 3 μm and a thickness of about 2 nm was purchased from Nanjing Xianfeng Nano Co., Ltd.

An expandable microsphere (model U41) with an average particle size of 10 to 20 μm, an expansion initial temperature of 80 to 85° C. and a maximum expansion (shrinkage) temperature of 120 to 130° C.) was purchased from Foshan Jusheng Chemical Co., Ltd.

An expandable microsphere (model 642WU40) with an average particle size of 10 to 16 μm, an expansion initial temperature of 87 to 93° C. and a maximum expansion (shrinkage) temperature of 127 to 135° C. was purchased from Expancel, the Netherlands.

A polydimethylsiloxane (PDMS) resin with model SYLGARDTM184 was purchased from Dow Corning Corporation, USA, including basic components and a curable agent.

An AF1601 resin with model TeflonTM AF1601 was purchased from Chemours, USA.

Dimethyl silicone oil with a viscosity of 100±8 mPa·s was purchased from Sigma Aldrich.

Perfluoropolyether oil was purchased from Sigma Aldrich with a molecular weight Mw of 1500.

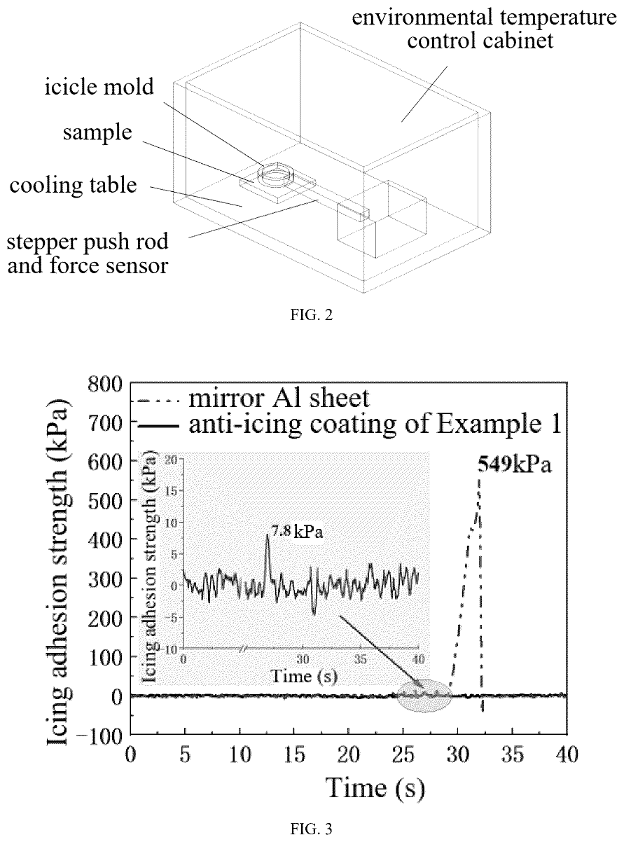

In embodiments of the present disclosure, an icing adhesion strength testing device is adopted to test an icing adhesion strength. As shown in FIG. 2, the icing adhesion strength testing device consists of an environmental temperature control cabinet, a cooling table, a (φ1 cm×5 mm) icicle mold, a stepper push rod, and a force sensor.

During a test, a temperature of the cooling table was controlled at −25° C., a temperature of the environmental temperature control cabinet was set at −10° C., a sample and the icicle mold were placed on a surface of the cooling table, and 1 ml of water was added dropwise to the icicle mold. Allow to stand for 5 min until water cooled and iced, the stepper push rod carrying the force sensor was adjusted to a cross-section of the icicle mold, with a center of a push rod head which is 1 to 2 mm away from the cross-section and a height which is 1 mm away from a surface of the sample.

Starting the test, the stepper push rod and the force sensor were controlled to move at a speed of 0.2 mm/s until the icicle undergone an interfacial shear fracture. The push rod was stopped and obtained force data is analyzed. Icing adhesion strength data is obtained by dividing a peak of an instantaneous force at a time of fracture in a process by an icing area (an area of a φ1 cm circle) of the icicle.

In embodiments of the present disclosure, an experimental xenon lamp is used to simulate sunlight irradiation on a coating sample. Under one sunlight irradiation (i.e., a light intensity being 96 mW/cm²), a sample surface temperature is measured using a Hikvision infrared thermal imager at a distance of 10 cm from the surface of the coating and a temperature of −10° C. of the cooling table (i.e., a sample substrate) to test an photothermal effect of the sample.

In embodiments of the present disclosure, a video contact angle meter and a cooling table are used to test a high delayed icing performance of the obtained coating, and on this basis, an icing delayed performance of the coating under an action of the photothermal effect is tested in combination with xenon lamp irradiation.

In embodiments of the present disclosure, the icing adhesion strength testing device shown in FIG. 2 is used to perform a long-term robustness test on prepared samples.

### Example 1

A method for preparing an anti-icing coating included the following steps.
(1) A substrate material was a mirror Al sheet with a size of 1.5 cm×1.5 cm×1 mm, and sandblasting was used to achieve a surface roughness level of about 10 μm.
(2) 100 mg of single-layer molybdenum carbide powders and 100 mg of expandable microsphere (model U41) were added one after another to a PDMS resin diluted with tetrahydrofuran (tetrahydrofuran:PDMS=1 ml:1 ml) and ultrasonicated for 6 h to uniformly disperse a solution formed thereby to obtain a colloidal solution.
(3) 600 μL of the colloidal solution was dripped on a surface of the sandblasted Al sheet obtained in step (1), which was heated at 50° C. for 30 min to remove tetrahydrofuran, was heated at 85° C. for 1 h to allow the expandable microsphere to begin to expand and the PDMS to cure and form, then was heated to 130° C. and maintained for 5 h to allow the expandable microsphere to fully shrink to form an internal three-dimensional pore structure, and finally was air cooled for 12 h to obtain a three-dimensional porous coating.
(4) After the three-dimensional porous coating was polished with sandpaper to remove a surface cured resin, an excess of dimethyl silicone oil (purchased from Sigma Aldrich, a viscosity of 100±8 mPa·s) was uniformly dropped on a surface of the three-dimensional porous coating and left for 30 min to fully infiltrate the coating. A sample was then placed vertically at 90° for 10 h to allow the excess oil on an outer layer of a surface of the coating to drain, thereby obtaining the anti-icing coating.

The sample was placed on a low-temperature cooling table set at a temperature of −25° C., and the sample was cooled for 10 min to ice, and was tested using an icing adhesion force device of the present disclosure. After testing, it was found that an icing adhesion strength was reduced by more than 97% compared with a test of icing directly performing on the mirror Al sheet under the same cooling conditions. As shown in FIG. 3.

### Example 2

A method for preparing an anti-icing coating included the following steps.
(1) A substrate material was a mirror Al sheet with a size of 1.5 cm×1.5 cm×1 mm, and acid etching was used to achieve a surface roughness level of about 10 μm.
(2) 150 mg of lignin powders (a particle size of 50 nm to 1 μm, and a purity of 93%) and 100 mg of expandable microsphere (model U41) were added one after another to 1 ml of AF 1601 resin and ultrasonicated for 6 h to uniformly disperse a solution formed thereby to obtain a colloidal solution.
(3) 600 μL of the colloidal solution was dripped on a surface of the acid etched Al sheet obtained in step (1), which was heated at 70° C. for 30 min, was heated at 85° C. for 1 h to allow the expandable microsphere to begin to expand and the resin to cure and form, then was heated to 125° C. and maintained for 5 h to allow the expandable microsphere to fully shrink to form an internal three-dimensional pore structure, and finally was air cooled for 12 h to obtain a three-dimensional porous coating.
(4) After the three-dimensional porous coating was polished with sandpaper to remove a surface cured resin, perfluoropolyether oil was uniformly dropped on a surface of the three-dimensional porous coating and left for 30 min to fully infiltrate the coating. A sample was then placed vertically at 90° for 10 h to allow the excess oil on an outer layer of a surface of the coating to drain, thereby obtaining the anti-icing coating.

The sample was placed on a low-temperature cooling table set at a temperature of −25° C., and the sample was cooled for 10 min to ice, and was tested using an icing adhesion force device of the present disclosure. After testing, it was found that an icing adhesion strength was reduced by more than 97% compared with a test of icing directly performing on the mirror Al sheet under the same cooling conditions. As shown in FIG. 3.

### Example 3

A method for preparing an anti-icing coating included the following steps.
(1) A substrate material was a mirror 304 stainless steel sheet with a size of 1.5 cm×1.5 cm×1 mm, and acid etching was used to achieve a surface roughness level of about 10 μm.
(2) 200 mg of high-quality thin-layer graphene (XF182-1) and 120 mg of expandable microsphere (model 642WU40) were added one after another to a PDMS resin diluted with tetrahydrofuran (tetrahydrofuran: PDMS =1 ml:1 ml) and ultrasonicated for 6 h to uniformly disperse a solution formed thereby to obtain a colloidal solution.
(3) 600 μL of the colloidal solution was dripped on a surface of the acid etched 304 stainless steel sheet obtained in step (1), which was heated at 50° C. for 30 min to remove tetrahydrofuran, was heated at 90° C. for 1 h to allow the expandable microsphere to begin to expand and the PDMS to cure and form, then was heated to 135° C. and maintained for 5 h to allow the expandable microsphere to fully shrink to form an internal three-dimensional pore structure, thereby obtaining a three-dimensional porous coating.
(4) After the three-dimensional porous coating was polished with sandpaper to remove a surface cured resin, dimethyl silicone oil (purchased from Sigma Aldrich, a viscosity of 100±8 mPa·s) was uniformly dropped on a surface of the three-dimensional porous coating and left for 30 min to fully infiltrate the coating. A sample was then placed vertically at 90° for 10 h to allow the excess oil on an outer layer of a surface of the coating to drain, thereby obtaining the anti-icing coating.

The sample was placed on a low-temperature cooling table set at a temperature of −25° C., and the sample was cooled for 10 min to ice, and was tested using an icing adhesion force device of the present disclosure. After testing, it was found that an icing adhesion strength was reduced by more than 96% compared with a test of icing directly performing on the mirror 304 stainless steel sheet under the same cooling conditions. As shown in FIG. 5.

### Example 4

The difference from Example 1 is that step (1) was performed as follows.

A substrate material was a mirror Al sheet with a size of 1.5 cm×1.5 cm×1 mm, and sandblasting was used to achieve a surface roughness level of about 10 μm.

100 μL of dimethyl silicone oil was added to 200 μL of PDMS resin and a solution formed thereby was stirred for 30 min to form a mixed liquid.

100 μL of the mixed liquid was transferred to a surface of the substrate after sandblasting, and was cured and formed at 85° C.

### Example 5

The difference from Example 4 is that an addition amount of the expandable microsphere was 80 mg.

### Example 6

The difference from Example 4 is that an addition amount of the expandable microsphere was 120 mg.

### Comparative Example 1

The difference from Example 4 is that an addition amount of the expandable microsphere was 10 mg.

### Comparative Example 2

The difference from Example 4 is that an addition amount of the expandable microsphere was 20 mg.

### Comparative Example 3

The difference from Example 4 is that an addition amount of the expandable microsphere was 150 mg.

### Comparative Example 4

The difference from Example 4 is that no expandable microsphere was added.

### Comparative Example 5

The difference from Example 4 is that no expandable microsphere and no photothermal nanomaterial were added.

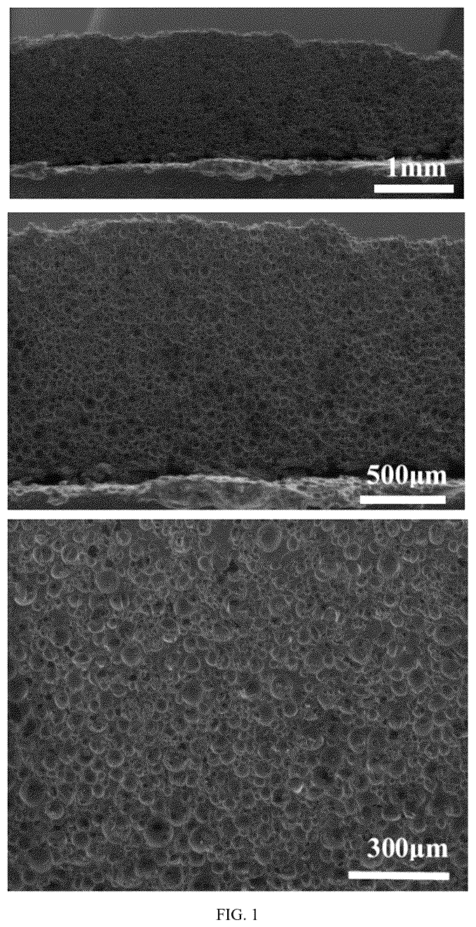

FIG. 1 is a cross-sectional characterization diagram of a three-dimensional porous coating prepared in Example 1 of the present disclosure. It may be seen from FIG. 1 that a coating prepared by adding 10% expandable microsphere has obvious three-dimensional porous morphology features.

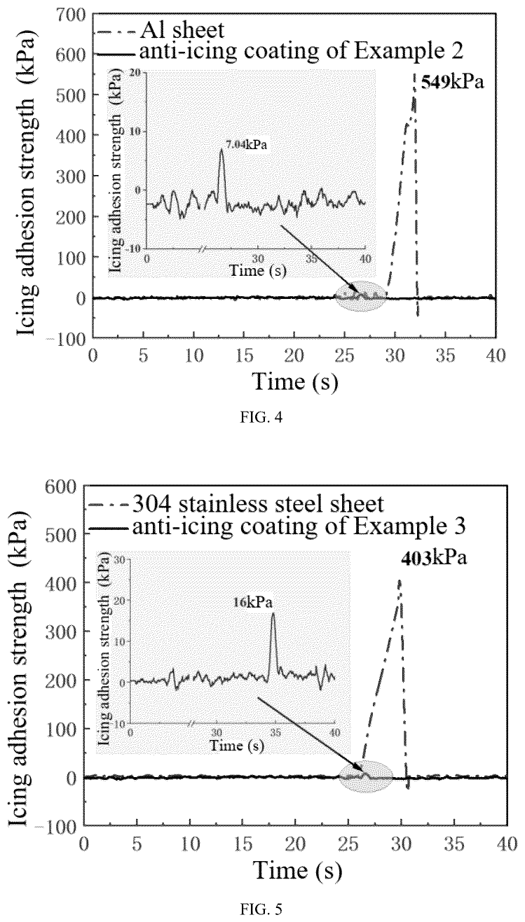

FIGS. 3 to 5 are changes in anti-icing adhesion strengths of substrates with and without an anti-icing coating in Examples 1 to 3. It may be seen from FIGS. 3 to 5 that a coating prepared by the present disclosure has a significant reduction in its icing adhesion strength compared to an untreated surface of a substrate, with a reduction being more than 95%. The icing adhesion strengths of the coatings prepared on an Al surface in Examples 1 and 2 are less than 10 kPa, and the icing adhesion strength of the coating prepared by treating on a 304 stainless steel sheet in Example 3 is less than 20 kPa, all showing a good anti-icing property.

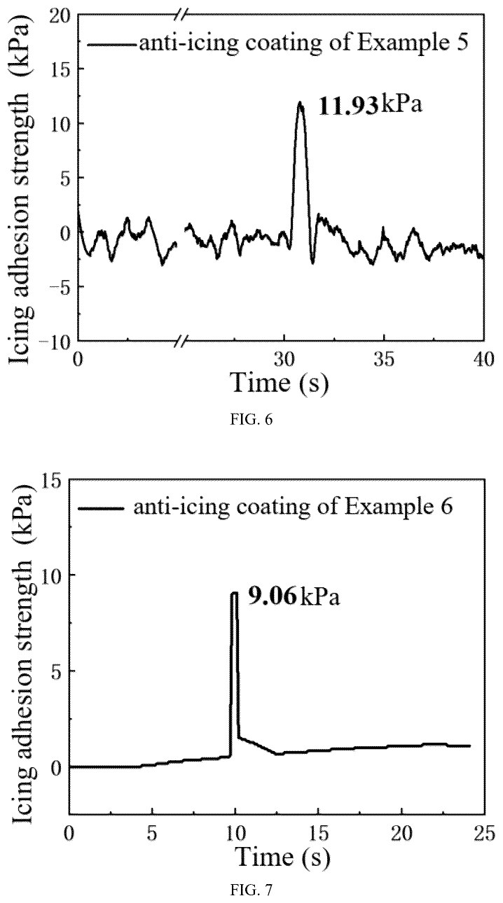

FIG. 6, FIG. 7, and FIG. 8 respectively show icing adhesion strengths of substrates with anti-icing coatings prepared in Example 5 (the icing adhesion strength less than or equal to 11.93 kPa), Example 6 (the icing adhesion strength less than or equal to 9.06 kPa), and Comparative Examples 1 to 5 (the icing adhesion strength less than or equal to 82 kPa for Comparative Example 1, the icing adhesion strength less than or equal to 85 kPa for Comparative Example 2, the icing adhesion strength less than or equal to 57 kPa for Comparative Example 3, the icing adhesion strength less than or equal to 113 kPa for Comparative Example 4, and the icing adhesion strength less than or equal to 103 kPa for Comparative Example 5). By comparison, it may be seen that the icing adhesion strengths of the substrates with the anti-icing coatings prepared in embodiments of the present disclosure are much lower than those in Comparative Examples 1 to 5.

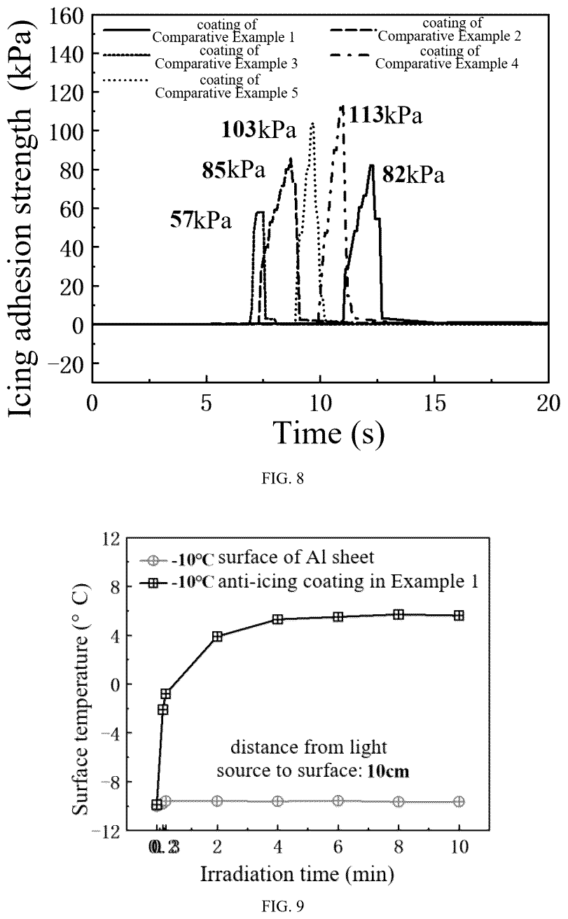

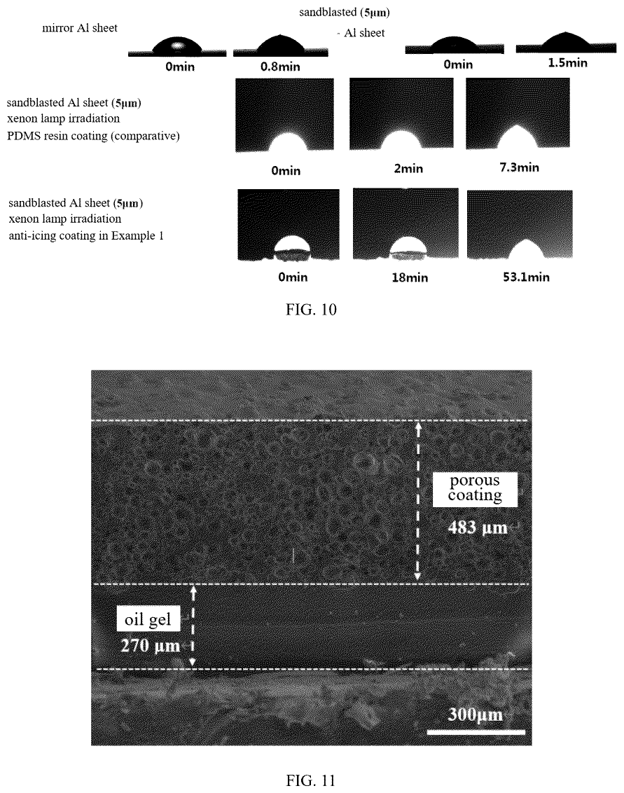

FIG. 9 is a comparison diagram of photothermal effects of substrates with and without an anti-icing coating in Example 1. It may be seen from FIG. 9 that a measured surface temperature of a sample is 16° C. higher than that of an ordinary Al sheet.

FIG. 10 is a comparison diagram of delayed icing time of substrates with and without an anti-icing coating in Example 1. A high delayed icing performance of an obtained coating is tested using a video contact angle meter and a cooling table, and on this basis, an icing delayed performance of the coating under an action of the photothermal effect is tested in combination with xenon lamp irradiation. It may be seen from FIG. 10 that an icing time of the substrate with the anti-icing coating in Example 1 of the present disclosure is extended to 33 times that of a mirror aluminum sheet.

FIG. 11 is a cross-sectional characterization diagram of a three-dimensional porous coating prepared in Example 4. It may be seen from FIG. 11 that a sandblasted substrate is subjected to a pretreatment with an oil gel to form an oil gel layer, on which the three-dimensional porous coating is formed. The presence of the oil gel layer enables a gradual release of contained oily liquid inside from an inner network to an outer layer, which helps to increase an oil storage performance of the three-dimensional porous coating and ensure more lasting and stable low icing adhesion features.

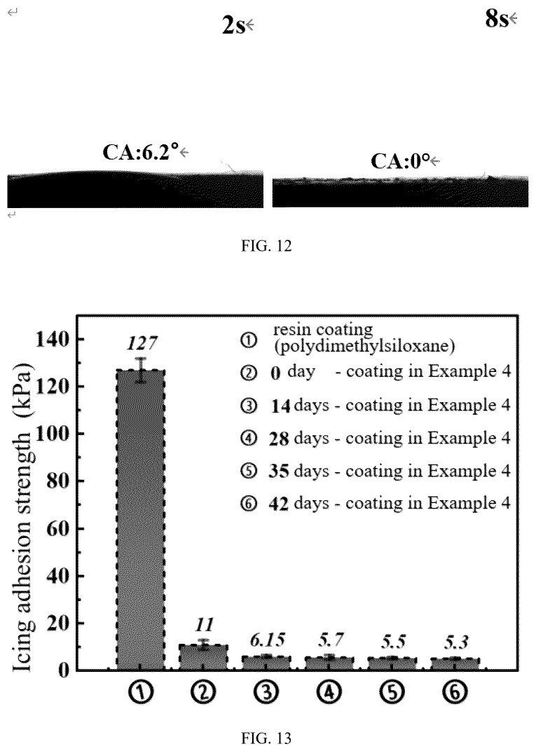

FIG. 12 is a result diagram of testing an affinity of a three-dimensional porous coating prepared in Example 4 for dimethyl silicone oil selected using a surface contact angle meter; after the three-dimensional porous coating is polished with sandpaper to remove a surface cured resin, 3 μL of dimethyl silicone oil is applied to a surface of the three-dimensional porous coating. A contact angle measured by the contact angle meter is 6.2°. After real-time observation for 8 s, the dimethyl silicone oil is completely absorbed by the three-dimensional porous coating, and a contact angle is 0°. It may be seen from FIG. 12 that a non-oiled three-dimensional porous coating prepared by the present disclosure has an excellent affinity for the dimethyl silicone oil selected and may be absorbed into an interior of the three-dimensional porous coating in a short time.

FIG. 13 is a long-term robustness test diagram of a sample prepared in Example 4 using an icing adhesion strength testing device in the present disclosure. In FIG. 13, a resin coating refers to a PDMS resin coating cured on a surface of a substrate. It may be seen from FIG. 13 that an anti-icing coating prepared in the present disclosure maintains extremely low icing adhesion performance for at least 42 days.

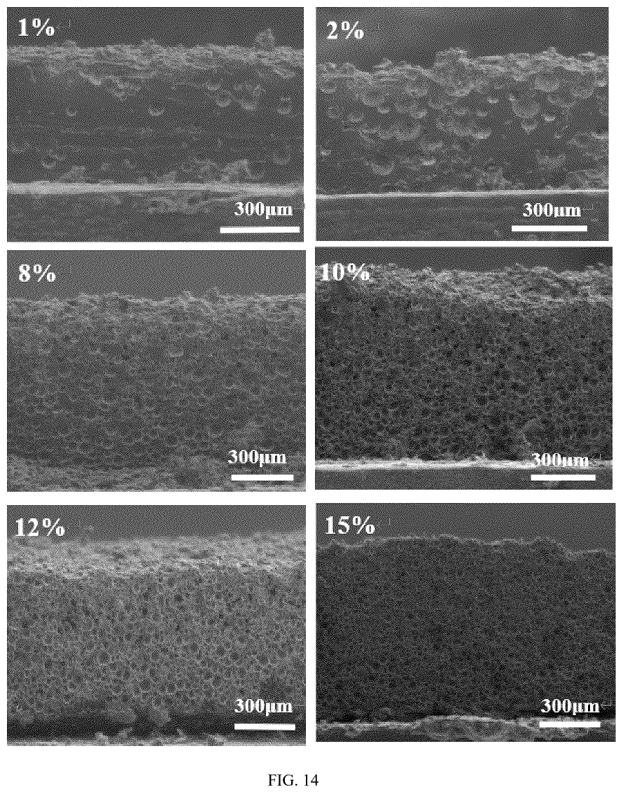

FIG. 14 is a cross-sectional characterization diagram of three-dimensional porous coatings prepared in Comparative Example 1 (1% in the figure), Comparative Example 2 (2% in the figure), Example 5 (8% in the figure), Example 1 (10% in the figure), Example 6 (12% in the figure), and Comparative Example 2 (15% in the figure). It may be seen from FIG. 14 that an addition content of an expandable microsphere has a very important influence on a construction of the three-dimensional coating. In a case where the addition content is low, a three-dimensional porous connected domain cannot be formed, resulting in the oily liquid further added in the S3 not being absorbed into an interior, thereby affecting a robustness of the low icing adhesion feature of the prepared coating; in a case where the expandable microsphere is added to an appropriate proportion, a three-dimensional porous connected domain may be formed on its surface, and a size of its porosity is closely related to an addition proportion. In a case where the proportion of the expandable microsphere is 8%, a porous structure just begin to form inside it. When 10% or 12% of the expandable microsphere is added, the porosity inside it further increases. In a case where the addition proportion is increased to 15%, a squeezing effect between the microspheres during an expansion process is aggravated due to a high addition proportion of the expandable microsphere, which further limits an expansion performance of a part of microspheres and the porosity is further reduced. Therefore, in the present disclosure, the addition proportion of the expandable microspheres is controlled to be 8 to 12 wt. %.

In the present disclosure, the terms “an embodiment,” “some embodiments,” “an example,” “a specific example,” or “some examples,” mean that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, those skilled in the art may combine the different embodiments or examples and the features described thereof in this specification without mutually inconsistent.

Although embodiments of the present disclosure have been shown and described, it would be appreciated by those skilled in the art that the above embodiments are illustrative and cannot be construed to limit the present disclosure, and changes, modifications, alternatives, and variations may be made in the above embodiments within the scope of the present disclosure.

1. A method for preparing an anti-icing coating, comprising:
in S1, adding a mixture of an expandable microsphere and a photothermal nanomaterial to a high-temperature curable resin diluted with a diluent solvent, and uniformly dispersing a solution formed thereby to obtain a colloidal solution;
in S2, transferring the colloidal solution to a surface of a substrate, heating the substrate with the colloidal solution attached thereto to volatilize the diluent solvent, and continuing heating the substrate to expand the expandable microsphere in the colloidal solution and to cure the high-temperature curable resin at or above an initial expansion temperature of the expandable microsphere; and heating the substrate to a maximum expansion temperature of the expandable microsphere to shrink the expanded microsphere, and cooling to obtain a three-dimensional porous coating; and
in S3, performing a surface treatment on the three-dimensional porous coating, and injecting an oily liquid to obtain the anti-icing coating.

2. The method for preparing the anti-icing coating according to claim 1, wherein the expandable microsphere has a particle size of 10 to 50 μm, the initial expansion temperature of 80 to 100° C., and the maximum expansion temperature of 120 to 140° C.

3. The method for preparing the anti-icing coating according to claim 1, wherein the expandable microsphere is of a core-shell structure, the core is a hydrocarbon, and the shell is an acrylonitrile copolymer.

4. The method for preparing the anti-icing coating according to any one claim 1, wherein the photothermal nanomaterial is a two-dimensional Mo₂C material.

5. The method for preparing the anti-icing coating according to any one claim 1, wherein in the S2, the colloidal solution is used in such an amount that makes the high-temperature curable resin corresponding thereto satisfies 100 to 300 μL/cm².

6. The method for preparing the anti-icing coating according to any one claim 1, wherein in the S1, the dispersion is carried out by an ultrasonic treatment with a frequency of 20 to 30 kHz for 6 to 8 h.

7. The method for preparing the anti-icing coating according to claim 6, wherein in the S2, the pretreatment further comprises coating the surface of the substrate with an oil gel after sandblasting or acid etching, followed by curing and forming; and the oil gel is a mixture of an oily liquid and a high-temperature curable resin in a volume ratio of 1:2, and the oil gel is coated in an amount of 100 μL/cm².

8. The method for preparing the anti-icing coating according to claim 7, wherein the oily liquid in a preparation of the oil gel is selected the same as the oily liquid in the S3; and the high-temperature curable resin in the preparation of the oil gel is selected the same as the high-temperature curable resin in the S1.

9. The method for preparing the anti-icing coating according to any one claim 1, wherein the substrate is selected from a metallic material, a non-metallic material, an inorganic material, an organic material or a composite material.

10. An anti-icing coating, prepared by the method according to claim 1.

11. (canceled)

12. (canceled)

13. The method for preparing the anti-icing coating according to claim 1, wherein the photothermal nanomaterial has a particle size of 20 nm to 5 μm.

14. The method for preparing the anti-icing coating according to claim 1, wherein an amount of the expandable microsphere is 8 to 12% of a mass of the high-temperature curable resin, and an amount of the photothermal nanomaterial is 10 to 20% of the mass of the high-temperature curable resin.

15. The method for preparing the anti-icing coating according to claim 1, wherein the photothermal nanomaterial is one or more of graphene, black phosphorus, MXene, ferroferric oxide, or lignin.

16. The method for preparing the anti-icing coating according to claim 1, wherein the high-temperature curable resin is one or more of polydimethylsiloxane, amorphous fluoropolymer, polytetrafluoroethylene, or polychlorotrifluoroethylene.

17. The method for preparing the anti-icing coating according to claim 1, wherein the oily liquid is dimethyl silicone oil or perfluoropolyether oil.

18. The method for preparing the anti-icing coating according to claim 1, wherein the high-temperature curable resin is polydimethylsiloxane.

19. The method for preparing the anti-icing coating according to claim 1, wherein in the S3, an injection amount of the oily liquid is 200 μL/cm² to a maximum adsorption capacity.

20. The method for preparing the anti-icing coating according to claim 1, wherein in the S1, the colloidal solution is maintained for 30 min to 2 h at or above the initial expansion temperature of the expandable microsphere to expand the expandable microsphere in the colloidal solution and to cure the high-temperature curable resin; and then is heated to the maximum expansion temperature of the expandable microsphere and maintained for 4 to 6 h to shrink the expanded microsphere.

21. The method for preparing the anti-icing coating according to claim 1, wherein in the S2, before transferring the colloidal solution to the surface of the substrate, the surface of the substrate is subjected to a pretreatment, and the pretreatment comprises sandblasting or acid etching to make the surface of the substrate have a roughness of 3 to 15 μm.

22. The method for preparing the anti-icing coating according to claim 1, wherein in the S3, the surface treatment is polishing the three-dimensional porous coating.
